(19) United States
(12) Patent Application Publication
(10) Pub. No.: US 2019/0051190 A1
(43) Pub. Date: Feb. 14, 2019

(54) AUTHORISATION MANAGEMENT AND FLIGHT COMPLIANCE SYSTEM AND METHOD FOR UNMANNED AERIAL VEHICLES

(71) Applicant: AGC SAFETY FLY DAC, Dublin (IE)

(72) Inventors: Brian RUSSELL, Dublin (IE); Ronan FARRELL, Dublin (IE)

(21) Appl. No.: 16/077,466

(22) PCT Filed: Mar. 7, 2017
(86) PCT No.: PCT/EP2017/055348

§ 371 Date: Aug. 11, 2018

Related U.S. Application Data
(60) Provisional application No. 62/304,832, filed on Mar. 7, 2016.

(30) Foreign Application Priority Data
Mar. 8, 2016 (EP) 16159229.0

(51) Int. Cl. G08G 5/00; G05D 1/00; B64C 39/02; H04L 9/32

(52) U.S. Cl. CPC G08G 5/0069; G05D 1/0027; B64C 39/024; H04L 2209/84; G08G 5/0039; H04L 9/3247; B64C 2201/146; G08G 5/0043

(57) ABSTRACT

An authorisation management and flight compliance system for a plurality of Unmanned Aerial Vehicles (UAV) operating in a region, said system configured to assess a flight command request for a UAV submitted by an authorised controller for approval, the assessment based on constraints for the flight and a level of authority assigned to the controller; and cryptographically sign an approved command request and return the signed command request to the controller for sending to the UAV.

### FIELD

The invention relates to an authorisation management and flight compliance system and method for Unmanned Aerial Vehicles (UAV). Such UAVs may be both autonomous and remotely piloted aircraft.

### BACKGROUND

Unmanned aerial vehicles (UAV) operate in a dynamic environment requiring pro-active control to ensure that the purpose of the UAV's flight is achieved and that safety and security is not compromised in the presence of other UAVs, aircraft, and environmental conditions. This becomes challenging when control needs to be provided beyond line of sight and thus command and control needs to be shared across localities and users.

US Patent Application Publication No. US 2014/0156109 discloses a collaborative routing system which is configured to receive a set of flight parameters from an operator of an unmanned aircraft system (UAS) control station for each individual aircraft, and based on the received flight parameters, current and projected airspace conditions, mission or ATC directive and/or any other information available to the collaborative routing system, automatically present the UAS control station with a set of flight plan options for each individual aircraft. However, there is no disclosure in this patent document of authenticating the operator. Furthermore, there is no disclosure of basing the set of flight plan options on the level of authority of the operator.

US Patent Application Publication No. US 2014/0163852 discloses a method whereby an operator of a UAV sends a flight plan to a management and control body. This body verifies if the flight plan is compatible with other missions that must be carried out in the airspace. Once defined, the flight plan is signed with the body's private key and is encoded with the public key of the UAV for which the flight plan is intended. Upon receipt of the flight plan by the UAV, a device authenticates the flight plan, by first decoding it with its own private key and then applying the public key of the management and control body. While this patent document mentions the use of authentication in the system, this authentication is solely in relation to the flight plan, with their being no mention of authenticating the operator who sends the flight plan. In addition, there is no mention of taking the assigned level of authority of the operator into consideration when verifying the flight plan.

It is an object of the invention to provide an authorisation management and flight compliance system and method for Unmanned Aerial Vehicles.

### SUMMARY

According to the invention there is provided, as set out in the appended claims,
an authorisation management and flight compliance system for a plurality of Unmanned Aerial Vehicles (UAV) operating in a region, said system configured to:
assess a flight command request for a UAV submitted by an authorised controller for approval, the assessment based on constraints for the flight and a level of authority assigned to the controller; and
cryptographically sign an approved command request and return the signed command request to the controller for sending to the UAV.

In one embodiment, the system is further configured to:

receive an authorisation request for access from a controller;

compare the controller against a competency list that details competence levels of all controllers for different types of UAVs; and

assign a level of authority to the controller based on the comparison.

Accordingly, the present invention provides an authorisation management and flight compliance system which uses a certificate-based encryption scheme, and where the system includes all controllers (user agents) as well as the flight compliance authority. By assigning an explicit level of authority to each controller, it enables the source of restrictions to be identified when flight plans are filed or modified.

In one embodiment, the controller comprises a human or a virtual pilot of the UAV.

In one embodiment, the constraints for the flight comprise a set of predetermined and dynamic policies.

In one embodiment, the policies comprise one or more of: appropriate height levels for the UAV, the spatial location of the UAV, the speed limit of the UAV, environmental conditions, safety conditions, regulatory conditions, or the location of other aerial vehicles.

In one embodiment, the UAV is configured to decode signed command requests received from the controller and acknowledge the command.

In one embodiment, the system is further configured to:

verify the correctness of a command acknowledged by the UAV; and

send an approval of a correct command for execution by the UAV.

In one embodiment, the controller is configured to submit the command acknowledged by the UAV for verification and wherein the approval of a correct command is sent to the controller.

In one embodiment, the system is further configured to dynamically update the assigned level of authority based on one or more external factors.

In one embodiment, the system is further configured to issue commands to override current flight plans, resource allocations and flight characteristics to return a UAV to a safe operating regime when the UAV is identified as being outside an acceptable operating regime.

In one embodiment, the system is further configured to permanently record approved and unapproved commands.

In another embodiment of the invention there is provided a method of ensuring authorisation management and flight compliance for a plurality of Unmanned Aerial Vehicles operating in a region, said method comprising the steps of:
assessing a flight command request for a UAV submitted by an authorised controller for approval, the assessment based on constraints for the flight and a level of authority assigned to the controller; and
cryptographically signing an approved command request and returning the signed command request to the controller for sending to the UAV.

In one embodiment the method further comprises:

receiving an authorisation request for access from a controller;

comparing the controller against a competency list that details competence levels of all controllers for different types of UAVs; and

assigning a level of authority to the controller based on the comparison.

In one embodiment the method further comprises:

decoding and acknowledging by the UAV signed command requests received from the controller.

In one embodiment the method further comprises:

verifying the correctness of a command acknowledged by the UAV; and

sending an approval of a correct command for execution by the UAV.

In one embodiment the method further comprises:

submitting by the controller the command acknowledged by the UAV for verification; and

sending the approval of a correct command to the controller.

In one embodiment the method further comprises dynamically updating the assigned level of authority based on one or more external factors.

In one embodiment the method further comprises issuing commands to override current flight plans, resource allocations and flight characteristics to return a UAV to a safe operating regime when the UAV is identified as being outside an acceptable operating regime.

In one embodiment the method further comprises permanently recording approved and unapproved commands.

In another embodiment there is provided an authorisation management and flight compliance system for a plurality of Unmanned Aerial Vehicles operating in a region comprising a plurality of controller entities wherein each controller entity is assigned a profile according to a policy requirement and matched with an Unmanned Aerial Vehicle; and a module to compare controller entity commands to control the Unmanned Aerial Vehicle operation complies with the assigned profile.

In one embodiment the profile defines an authorised Unmanned Aerial Vehicle operation in a defined region based on a competency assigned to a controller entity.

In one embodiment each command is analysed such that the operation of the UAV remains within the policy requirements of the region of operation.

In one embodiment the, or each, Unmanned Aerial Vehicle is configured to decode and detect authorised commands from a controller entity over a communications channel.

In one embodiment there is provided means to dynamically update the assigned profile based on one or more external factors.

In one embodiment the controller entity can only be used by an authorised user.

In one embodiment there is provided means for ensuring that only validated controller entity commands can be used.

In one embodiment there is provided means of revoking the profile when authorised Unmanned Aerial Vehicle operation in a defined region does not comply with the assigned profile.

In one embodiment there is provided a central database for comparing Unmanned Aerial Vehicle operation with the assigned profile and determining future assigned profiles in accordance with previous Unmanned Aerial Vehicle operation.

In another embodiment there is provided a method of ensuring authorisation management and flight compliance for a plurality of Unmanned Aerial Vehicles operating in a region, said method comprising the step of assigning a plurality of controller entities a profile according to a policy requirement and matched with an Unmanned Aerial Vehicle; and comparing controller entity commands to control the Unmanned Aerial Vehicle operation complies with the assigned profile. In one embodiment this profile can comprise a collection of roles, rights, competencies and metadata that completely describe a controller (User Agent).

In one embodiment there is provided a system and method are provided for the control of unmanned aerial vehicles by one or more persons, ensuring compliance with safety and regulatory conditions. It presents a hierarchical scheme for granting users appropriate levels of authorities based upon predefined roles and location; for transferring data between the aerial vehicle, controllers, and a flight compliance authority; for operational constraints to be distributed to users and aerial vehicles from the operations centre; for ensuring that users and aircraft are aware of local environmental conditions including other aerial vehicles; for ensuring that all user-requested command requests are compliant with the system and local environment operational constraints. This method permits a dynamic assignment of authority to control unmanned aerial vehicles to a variety of users while maintaining safe and robust operation.

In one embodiment there is provided a flight compliance and user authorisation mechanism for UAVs.

In one embodiment there is provided a means of comparing flight control requests to a set of predetermined and dynamic policies on a per-request basis.

In one embodiment there is provided a means of ensuring unqualified users cannot use UAVs beyond their competency.

In one embodiment there is provided a means of ensuring that only validated commands can be used to control a UAV.

In one embodiment there is provided a flight compliance and user authorisation mechanism for UAVs. This provides a mechanism for ensuring that only valid commands generated by authorised users are acted upon by the UAV. The scheme ensures that the impact of each command is considered and that the operation of the UAV will remain within the policy requirements of the region of operation. The scheme envisages built-in systems in the UAV to decode and detect authorised commands and secondly at the user to ensure identification of an appropriate user (e.g. biometrics, passwords, etc) against a central database. These checks will be frequent to prevent impersonation, malicious or unintentional, of authorised users.

In one embodiment there is provided a means of comparing flight control requests to a set of predetermined and dynamic policies on a per-request basis. A central service will model the impact of each request or command to the UAV to assess the proposed future behaviour of the UAV. This will be then be compared with a set of policies to assess whether the UAV remains in compliance (e.g. at appropriate height levels, within a specific space, within speed limits, away from other aircraft). This central service can receive policy updates that may be time limited or may require immediate compliance (e.g. temporary exclusion zones around some event or emergency restrictions). Existing pre-coded geo-fencing solutions in current UAVs cannot support this.

In one embodiment there is provided a means of ensuring unqualified users cannot use UAVs beyond their competency. This solution envisages a database (centralised or distributed) that contains information about individual users—for example training, licenses, medical issues, etc. This information will be used when a user requests control of a UAV. Based on the flight characteristics of the UAV, weight and other factors, the user will be granted a limited range of abilities for that UAV. In this way, unqualified users cannot use UAVs beyond their competency. Where it does occur, the system will remove control and return the UAV to an acceptable safe mode of operation.

In one embodiment there is provided a means of ensuring that only validated commands can be used to control a UAV. This is a security feature to ensure that malicious or unauthorised commands cannot be sent to a UAV. There are a range of issues that could occur: For example: a) Modifying validated commands for a different UAV; b) Modifying validated commands for the same UAV but at a different time or space. The solution envisages an encryption mechanism that utilises spatial, temporal coordinates as well as a unique numerical identifier for the UAV to ensure that only valid commands are acted upon. This is enforced by a query-response cycle where the UAV must paraphrase the request to the FCA for acknowledgement—thus ensuring a correct understanding has been received.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:

FIG. 1 illustrates an overall architecture of the authorisation management and flight compliance architecture, according to one embodiment of the invention;

FIG. 2 illustrates how a new controller can be registered to the system, according to one embodiment;

FIG. 3 illustrates a methodology for ensuring the UAV is aware of approved flight controller requests;

FIG. 4 illustrates authorisation management and flight compliance architecture incorporating a policy module, according to another embodiment; and

FIG. 5 illustrates one embodiment of the logging mechanism for operating commands.

### DETAILED DESCRIPTION OF THE DRAWINGS

This invention provides a method for ensuring compliance with legal and operational policies for UAVs and in ensuring appropriate authorisation to controllers in different regions and with differing levels of authority based on predefined roles within an Unmanned Aircraft System (UAS). This system may comprise for example a complete system encompassing all elements required to fly an unmanned aircraft, including the airborne vehicle and ground control (if any). In addition, a flight compliance authority provides oversight on all commands to ensure that there is the appropriate level of authority and that it complies with all safety, mission, and other operational constraints. A command comprises a precise, but high-level description of an action to be executed by an aircraft. It will be appreciated that the available commands are dependent on aircraft type.

The flight compliance authority is the root organisation from which all authority derives. This may be a regional or national airspace authority. It can be a single located facility or may comprise of a distributed network of facilities. The operations centre can be full automated, operated by humans, or a mixture of the two. In addition, the solution ensures against intentional or unintentional interference with the commands being sent to the UAV—thus preventing hijacking, spoofing or other techniques used to interfere with the legitimate use of these aircraft.

The invention encompasses both the scenario of a single-owner network of UAVs with multiple possible users or the case of multiple combinations of owners and UAVs sharing a common airspace. In the latter case, an example would be that of a national regulatory framework above a certain height where the flight compliance authority could be a government owned entity.

In the described method, users or agents with the ability to adjust the flight characteristics of a UAV by means of furnishing operating commands to a UAV, are called controllers, and may comprise a human or a virtual pilot (they are also commonly known as “User Agents”). These controllers are assigned a role for a particular UAV, or category of UAV within the system. Thus, in the described method, users interact with the system via these User Agents: electronic or software interfaces which can issue operating commands. Each user is represented by exactly one User Agent and their ability to adjust flight characteristics are encoded via assigned roles and rights. Rights are dynamically assessed when an operating command is invoked, considering the particular unmanned aircraft, mission, pilot and operating environment in use. This role corresponds to a named collection of rights granted to the controller, and may be time-limited, for example for a specific flight, or a number of hours, periodic or indefinite. Roles are created and administered by organisations that derive their authority hierarchically from the compliance authority. The authority associated with each role will be within a hierarchical structure. Each role shall delegate a subset of rights to operate UAV functions or access resources to the role directly underneath. Each delegated subset will include a set of operational constraints on the use of these rights. Lower roles will thus have a reducing set of resources or functions available to them, and thus a decreasing ability to modify the UAV flight characteristics.

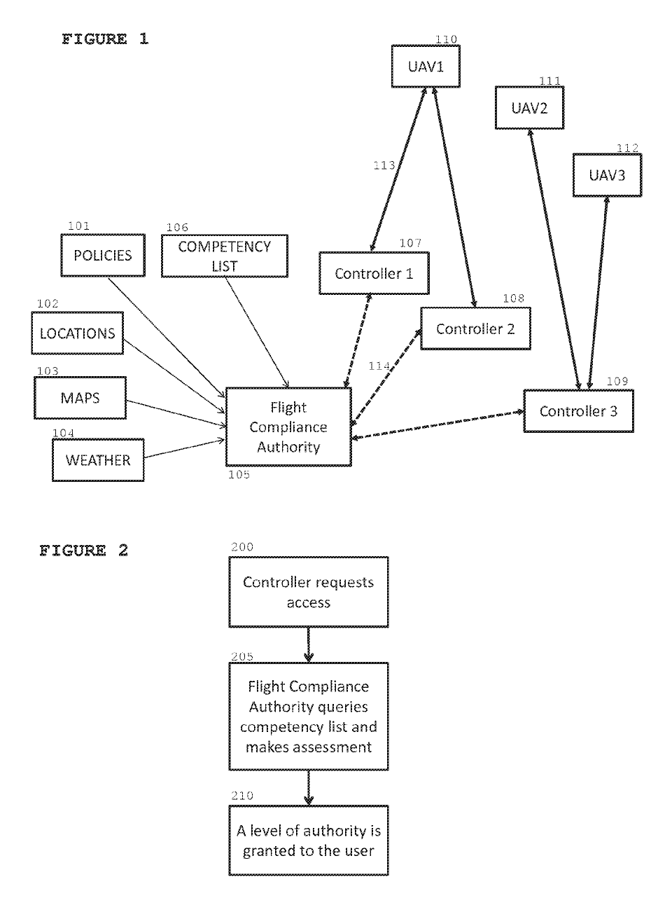

FIG. 1 illustrates the overall architecture of the authorisation management and flight compliance architecture, according to one embodiment of the invention. A Flight Compliance Authority (105) receives data from a number of sources. These sources can include policies (101) on the use of restricted airspace (sourced from government or 3^{rd} party agencies); it could include the locations to of all relevant aerial vehicles (102), maps on the geography of the relevant area (103), weather conditions (104) and any other relevant activity. These will be used to determine the range of acceptable UAV operations. In addition, the Flight Compliance Authority will receive a competency list (106) that details the competence level of all controllers for different types of UAV. This will be used to determine the level of authority that can be granted to each controller. The controllers (107,108,109) may control, independently or jointly, one or more aircraft (110,111,112). The controllers will maintain a secure link back to the Flight Compliance Authority (114) where controller requests are submitted and returned if approved. The controllers will also maintain a secure link to the UAV (113) whereby those commands and any other relevant information may be sent to the UAV and telemetry and other data returned.

An example of the different roles that a controller (107,108,109) may have within this hierarchical structure is as follows:
Level 1: the role with the highest level of rights and access to all available resources. This is envisaged for the flight compliance authority (FCA) which ensures safe operation and compliance with all legal and operational policies. The FCA will receive a variety of inputs. One category of inputs will include policies as may be generated by national aviation authorities or supplied by industry providers. Other types of input can include dynamic information such as plane locations and weather conditions.
Level 2: this role could be granted to those with authority to add or remove UAVs from the system—for example by authorising and initiating flight plans for the UAV. A flight plan corresponds to a precise description of an intended mission, detailing aircraft, pilot, airspace and route expressed in waypoints.
Level 3: granted to an experienced controller who can modify flight plans dynamically with full access to the UAV capabilities—based on the needs of the flight mission (i.e. the real-world execution of a flight plan). Examples include tracking drown targets (pylons, antennas, forest fires). The controller may be an experienced human pilot or an automated system with a higher level of trust and safety.
Level 4: this role could be assigned to a less capable ground-based controller who could be assisting the Level 3 controller, or may be under training.
Level 5: role envisaged to represent the on plane demand controller for the system and the flying platform for the drone system. This role has the least rights. In this case, the UAV on-board controller can only adjust the UAV resources in order to make best effort to comply with the ground-based controllers flight plan and other flight characteristics.

An example of the function and their associated parameters settings that could be assigned to each role include:

| Resource | Level 1 | Level 3 | Level 5 |
|---|---|---|---|
| X, Y | define restricted | Input planned flight | Only in case of |
| coordinates | airspace | path boundaries pre | collision |
| | | take off. | avoidance |
| | | These then set as | |
| | | the resource | |
| | | parameters | |
| Altitude | Set maximum and | Input planned flight | None |
| | minimum per | path boundaries pre | |
| | platform type per | take off. | |
| | region | These set a | |
| | | resource | |
| | | parameters | |
| Directional | Parameters fully | Full access | Only in case of |
| control | delegated | | collision |
| | | | avoidance |
| Pitch, Yaw | Parameters fully | Parameters fully | Parameters |
| | delegated | delegated | delegated to |
| | | | maintain flight |
| | | | path directions |
| | | | from level |
| | | | 3 user |

The level of authority granted to controllers at levels 3 and 4 will be based on some assessed competence and in compliance with any relevant regulatory policies. The type of UAV under control will also determine the level of competence and range of capabilities granted to the controller.

The flight compliance authority (FCA) will define the safe operating requirements and ensure compliance for all UAV flight requests under its control to those requirements and any other constraints. The primary purpose of this is to ensure safe operation. The FCA will take into account the category of UAV being used and can apply different requirements to different categories—such as small recreational drones to large heavy-lifting aircraft. Examples of such additional constraints include:
Policies on use of restricted airspace zones
Weather conditions (storms, rain, wind)
Locations of physical obstacles
Awareness of other aerial vehicles in the vicinity

The flight compliance authority should update its awareness of the operational environment regularly through mapping, liaising with national and regional authorities, flight data (ADS-B, MLAT) meteorological services, and other sources of relevant information. The flight compliance authority will ensure that all flight plan modifications comply with up-to-date information.

All controller requests to adjust flight characteristics or resources will be passed to the flight compliance authority for assessment and approval. In addition, the flight compliance authority will maintain a record for the current location of all UAVs under its remit. Where the flight compliance authority identifies an UAV to be outside of an acceptable operating regime—due either to inappropriate commands from a controller, or due to changes in external conditions such as weather or restricted air-space, the flight compliance authority can issue commands to override current flight plans, resource allocations and flight characteristics to return the UAV to a safe operating regime. All controllers will be informed of the cause of the override and it will be logged for traceability.

FIG. 2 illustrates the registration of a new controller to system. The controller (200) requests access. The Flight compliance authority will compare the controller against the competency list and any other policy or access conditions and make an assessment of the level of authority to be granted to that user agent or controller. Such policies may include for example one or more regulatory, safety and operational rules which are to be enforced. That assessment will be stored for later use in judging flight control requests.

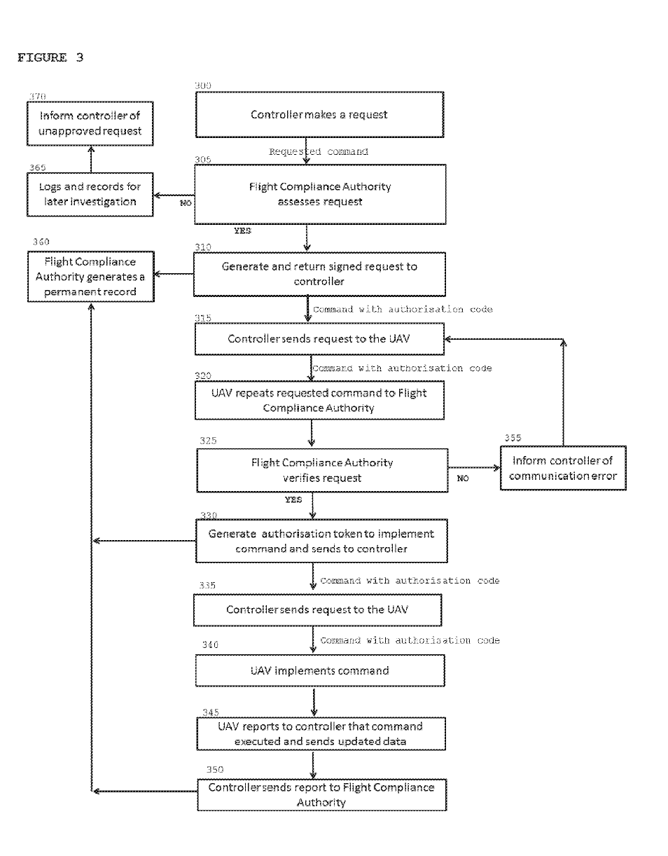

FIG. 3 illustrates a methodology for ensuring the UAV is aware of approved flight controller requests. The controller (300) will make a request to the Flight Compliance Authority (305). The flight compliance authority will assess the request based on the constraints for the flight and the level of authority granted to the controller. If this request is not approved, the failure is logged (365) for potential later investigation and the controller is informed of an unapproved command (370). For successful requests, a digital signature is generated from the data provided in the request and other pertinent information (310). This is returned to the controller who sends it to the UAV (315). The UAV then assesses the received communication and determines the authorisation code and the received command. It repeats this back to the controller (320). The controller then verifies the repeated command with the flight compliance authority (325). If the received command is correct, the flight compliance authority will send an authorisation token and command for the UAV to execute the received command (330) which will be passed by the controller to the UAV (335). If the flight controller determines that the UAV has received an incorrect command, then the controller is informed of a communications error (355) and the command to the UAV will require retransmission (315). Upon receipt of the correct command and approval to execute, the UAV will implement the command (340) and report back to the controller that it has done so and will provide any relevant updated information (345). The controller will pass this date to the flight compliance authority (350) for storage as a permanent record (355).

To ensure that valid commands have been received by the UAV and that the UAV remains under active control, the authorisation sequence for a command is as follows:
The authorised controller requests a command from the flight compliance authority
The flight compliance authority approves the request and cryptographically signs the request to be sent to the UAV
The UAV receives and decodes the request.
The UAV repeats back to the flight compliance authority the requested command
The flight compliance authority verifies the command requested and if correct sends the approval to execute the command.

In this way, incorrect or unapproved commands cannot be transmitted without the approval of the flight compliance authority. This provides an additional layer of security against unauthorised usage or hijacking of the UAV.

The Flight Compliance Authority will ensure that all aspects of the system remain secure and trustworthy. All communication links to both controllers and UAVs will need to comply with pre-agreed performance characteristics and security considerations. The radio link between the controller and the UAV can be implemented using a variety of technologies, but it is possible that a minimum required performance may be mandated by regulators. An example of such a system may be the need for a long range low bandwidth link for telemetry. With any communications link, there is the possibility of errors occurring in the link due to naturally occurring noise, accidental interference by other users, or by intentional interference. To ensure again against accidental commands being received due to communication errors, the system is adapted to construct commands and authorisation codes such that they are sufficiently distinct so that errors have a low probability of accidentally triggering an un-intended behaviour. One implementation of this is to ensure that there is a sufficient Hamming separation in the codes.

The authorisation codes can be generated using a combination of temporal, spatial data and data from the UAV, such as a unique id, or from other data provided by the controller request, as illustrated in FIG. 2. This signature can be queried by the UAV to select between approved and unapproved controller commands. This could be implemented with dedicated hardware or software systems. In the absence of approved commands to the UAV, or if an excess of un-approved commands are received, beyond some threshold, the UAV can take some predetermined action such as returning to a safe location. The use of time-based codes prevents reuse of the authorisation codes outside of an approved time period. The spatial codes prevent use outside of a specific region. The UAV specific data prevents use of authorisation codes for different UAVs.

In one embodiment of the invention, absolute location and heading data are used to calculate flight path and/or compare with the rule set, in order to reduce the computational load of the system. Using limited relative location (pitch, yaw) data reduces the load, and thus improves responsiveness and performance, especially with dense nodes. However it will be appreciated that in this embodiment of the invention it is important to periodically validate the absolute function, so as to ensure that no compounding errors can occur.

For all or some certain classes of UAVs, there will be an integrated system for periodic validation (for example short period timescales of 5-10 minutes) of the controllers to prevent impersonation or access by unauthorised users. An example of such a system could be the periodic testing of some biometric features of the controller within a specific timeframe and physical location.

It will be appreciated that the interval parameter for periodic validation could also be assigned through the use of profiles and flight paths. For example, a novice pilot with low user profile rights could be assigned a shorter interval parameter, in order to provide more robust monitoring of their flight.

Where a UAV loses contact with a controller in excess of some agreed time limit, or the controller becomes unresponsive, the UAV and the flight compliance authority will, together or independently, select a safe return to a pre-defined location.

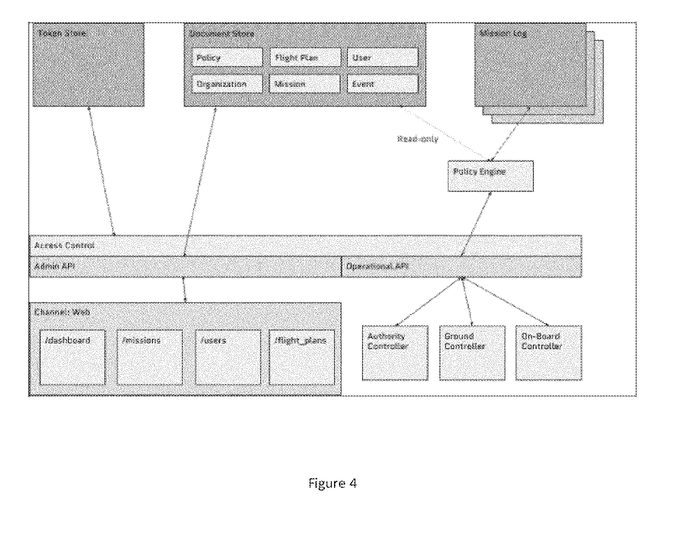

FIG. 4 illustrates a more detailed architecture incorporating a policy module. The architecture is configured with a mechanism of comparing flight control requests to a set of predetermined and dynamic policies on a per-request basis. A central service will model the impact of each request or command to the UAV to assess the proposed future behaviour of the UAV. This will be then be compared with a set of policies to assess whether the UAV remains in compliance (e.g. at appropriate height levels, within a specific space, within speed limits, away from other aircraft). This central service can receive policy updates that may be time limited or may require immediate compliance (e.g. temporary exclusion zones around some event or emergency restrictions). Existing pre-coded geo-fencing solutions in current UAVs cannot support this.

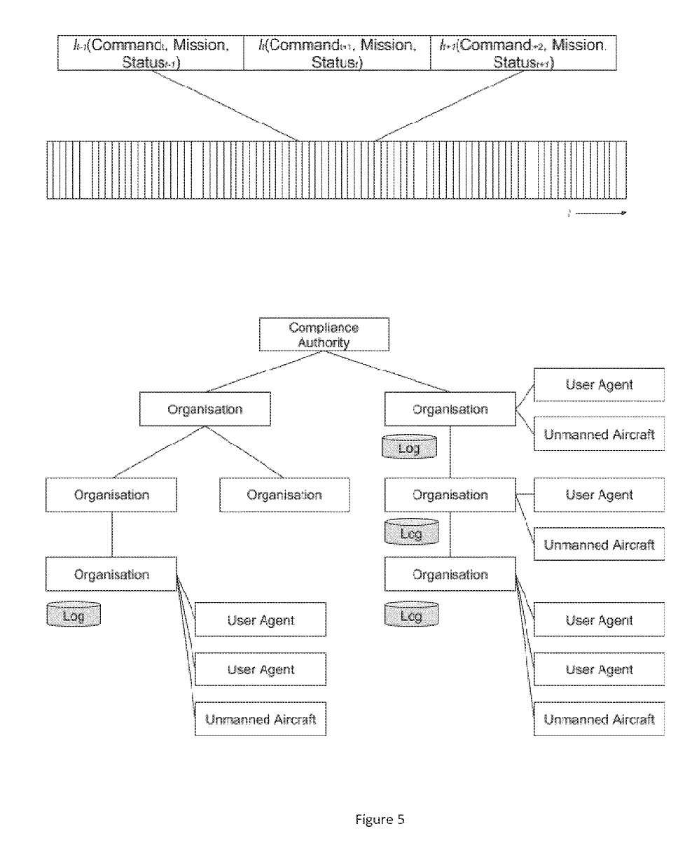

FIG. 5 illustrates the logging mechanism for the flight compliance system. All issued operating commands are recorded, whether approved (valid) or unapproved (invalid), at the site of the policy module, which is typically the delegated organisation controlling the airspace sector in question. Entries are of fixed length, encoded using a digest of the previous entry and solely appended to the command log. This mechanism prevents tampering, and can be used to ensure correctness of copied or stored logs, without recourse to a primary source. In one embodiment, command logs may be streamed to parent organisations, and ultimately to the flight compliance authority, providing eventual consistency, redundancy and independently verifiable records for the organisation. In another embodiment, the command logs are not streamed up the organisation hierarchy to the compliance authority, but may be queried by parent organisations on demand, providing a distributed log. Having the record allows a review of history events within a mission, such as for example following an incident, where a review akin to an aircraft black box can occur. Logs may also be used to backtest proposed policies and to refine existing policies.

An extension on the invention is to allow users agents and vehicles (levels 3 to 5) to have flexibility to temporarily exceed their authority in order to avoid collisions or take opportunistic advantage of a situation. This flexibility would be limited in time and the scope of possible alternation of resource usage and flight characteristics. In such a scenario, the level of flexibility granted would be based on the controller's assessed capability and in line with relevant regulatory or operational policies. In all cases the flight compliance authority would monitor the requested changes and would ensure compliance with overall safety criteria and force a return to normal controller and UAV behaviour once the level of flexibility has been exceeded.

Policy sets can be contributed by independent authorities. They need not collaborate and can add conflicting rules to be rectified before execution. They do not need to participate in rectification, which may be in real time or sequenced and distributed across locations. Policies can be digitally signed and time-bound, so their provenance can be verified. In composite policies, each layer is signed forming a policy chain. Each UAV can be identified and no additional rules can be inserted without invalidating the policy. An important aspect of the system is that updated policies can be pushed or broadcast to each UAV configured to operate in a particular region. This can be important for example in the event of extreme weather, a sporting event or a terrorist event, where the policy can be pushed to each UAV to generate a no fly zone in a particular region. Updated or new policies can be pushed from the system to one or more UAVs operating in a particular region without the UAV requesting an update policy. The system incorporating the invention can operate a standalone discrete system monitoring a particular region, but can also be configured to share information with neighbouring or other regions operating similar standalone systems.

It will be appreciated that the system can make use of security certificates. For example, communication channels are encrypted using time-bound identifying certificates, originally issued by the system. The system is configured with the authority to issue certificates and can be delegated from the central system. Each UAV can contain hardware-embedded serial identification used with a digital certificate to open channels or sign messages.

Rights can be assigned to UAV's as well as competency, and may be delegated or inherited within a hierarchy, i.e. there is a permissions hierarchy both for policies and commands. Commands can be digitally signed and time-bound. When acknowledging commands, the UAV need only return a token not the full command. When using a distributed policy store, commands can be sent to the relevant authority not the global system.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. An authorisation management and flight compliance system for a plurality of Unmanned Aerial Vehicles (UAV) operating in a region, said system configured to:
assess a flight command request for a UAV submitted by an authorised controller for approval, the assessment based on constraints for the flight and a level of authority assigned to the controller; and
cryptographically sign an approved command request and return the signed command request to the controller for sending to the UAV.

2. The system of claim 1, wherein the system is further configured to:
receive an authorisation request for access from a controller;
compare the controller against a competency list that details competence levels of all controllers for different types of UAVs; and
assign a level of authority to the controller based on the comparison.

3. The system of claim 1, wherein the controller comprises a human or a virtual pilot of the UAV.

4. The system of claim 1, wherein the constraints for the flight comprise a set of predetermined and dynamic policies.

5. The system of claim 4, wherein the policies comprise one or more of: appropriate height levels for the UAV, the spatial location of the UAV, the speed limit of the UAV, environmental conditions, safety conditions, regulatory conditions, or the location of other aerial vehicles.

6. The system of claim 5, further wherein the UAV is configured to decode signed command requests received from the controller and acknowledge the command.

7. The system of claim 6, wherein the system is further configured to:
verify the correctness of a command acknowledged by the UAV; and
send an approval of a correct command for execution by the UAV.

8. The system of claim 7, wherein the controller is configured to submit the command acknowledged by the UAV for verification and wherein the approval of a correct command is sent to the controller.

9. The system of claim 1, wherein the system is further configured to dynamically update the assigned level of authority based on one or more external factors.

10. The system of claim 1, wherein the system is further configured to issue commands to override current flight plans, resource allocations and flight characteristics to return a UAV to a safe operating regime when the UAV is identified as being outside an acceptable operating regime.

11. The system of claim 1, wherein the system is further configured to permanently record approved and unapproved commands.

12. A method of ensuring authorisation management and flight compliance for a plurality of Unmanned Aerial Vehicles operating in a region, said method comprising the steps of:
assessing a flight command request for a UAV submitted by an authorised controller for approval, the assessment based on constraints for the flight and a level of authority assigned to the controller; and
cryptographically signing an approved command request and returning the signed command request to the controller for sending to the UAV.

13. The method of claim 12, further comprising:
receiving an authorisation request for access from a controller;
comparing the controller against a competency list that details competence levels of all controllers for different types of UAVs; and
assigning a level of authority to the controller based on the comparison.

14. The method of claim 12, further comprising: decoding and acknowledging by the UAV signed command requests received from the controller.

15. The method of claim 14, further comprising:
verifying the correctness of a command acknowledged by the UAV; and
sending an approval of a correct command for execution by the UAV.

16. The method of claim 15, further comprising:
submitting by the controller the command acknowledged by the UAV for verification; and
sending the approval of a correct command to the controller.

17. The method of claim 12, further comprising dynamically updating the assigned level of authority based on one or more external factors.

18. The method of claim 12, further comprising issuing commands to override current flight plans, resource allocations and flight characteristics to return a UAV to a safe operating regime when the UAV is identified as being outside an acceptable operating regime.

19. The method of claim 12, further comprising permanently recording approved and unapproved commands.

20. (canceled)

21. A non-transitory computer-readable storage medium comprising program instructions for:
assessing a flight command request for an Unmanned Aerial Vehicle (UAV) submitted by an authorized controller for approval, the assessment based on constraints for the flight and a level of authority assigned to the controller; and
cryptographically signing an approved command request and returning the signed command request to the controller for sending to the UAV.
